(19) United States
(12) Patent Application Publication
(10) Pub. No.: US 2011/0208498 A1
(43) Pub. Date: Aug. 25, 2011

(54) SIMULATION OF THE EVOLUTION OF A MIXED MEDIUM BY ASYNCHRONOUS AND CHAOTIC PROCESSING, IN PARTICULAR FOR A VIRTUAL TEST TANK

(75) Inventors: Christophe Le Gal, Brest (FR); Pierre Antoine Beal, Brest (FR); Jacques Tisseau, Brest (FR); Christian Charles, Plougonvelin (FR)

(73) Assignee: CerVAL, Plouzane (FR)

(21) Appl. No.: 12/672,365

(22) PCT Filed: Aug. 5, 2008
(86) PCT No.: PCT/FR2008/001171

§ 371 Date: Oct. 13, 2010

(30) Foreign Application Priority Data
Aug. 6, 2007 (FR) 07/05731

(51) Int. Cl. G06F 17/50

(52) U.S. Cl. 703/9

(57) ABSTRACT

The invention relates to a real-world simulation device suitable for being installed in a computer designed to support a multitask programming environment (23). The device comprises a simulation manager (30), capable of working in asynchronous chaotic mode by repetitive sequences (31) on distinct simulation elements (40-70). Each simulation element works with at least one space/time datum, termed the structure point. A space/time datum includes a property datum, defining a current state of the structure point, and designates a function, applicable for modifying this current state. Said simulation manager (30) comprises two coupled simulation sections, namely a first and a second section, that are designed to simulate respectively a fluid medium and a solid body in the presence of said fluid medium. The manager (30) maintains a general periodicity of activation of the simulation elements which differs according to the physical phenomena simulated, in either of the two simulation sections

The invention relates to a computer simulation (or modeling) of the evolution over time of media which are subject to physical phenomena, e.g. liquid, gaseous, solid, particulate and similar media.

Published patent WO 2005/081141 introduced a new technique for simulation by asynchronous chaotic agents, and this was developed in WO 2006/003271. However, this new technique still has limitations, in particular because it makes it impossible to process certain types of interaction together, at least while remaining convergent. This will be described in detail below.

The present invention is intended to improve the situation.

It is based on a device for simulating the real world, in particular for a fluid/body interaction. This device is suitable for being installed in a computer which is equipped for supporting a multi-tasking programming environment, with a simulation manager, which is capable of working in asynchronous chaotic mode by repetitive sequences on distinct simulation elements.

Such a simulation element can work with at least one space/time data item, called a structure point, with at least one attribute data item, defining a current state of the structure point, and with the designation of at least one function, which can be used to modify this current state.

According to one aspect of the invention, the simulation manager comprises a first simulation section, which is configured to simulate a fluid medium, and a second simulation section, which is configured to simulate one or more substantially solid bodies, in the presence of the fluid medium; the two simulation sections are coupled; and the simulation manager is configured so as to maintain a general periodicity of activation of the simulation elements which differs according to the simulated physical phenomena in one and the other of the two simulation sections.

In a particular application, the first simulation section is used to simulate the sea, and the second simulation section is used to simulate one or more bodies which are floating and/or at least partly dipping into the sea, making it possible to produce a virtual test tank.

On another level, the first simulation section can be configured to simulate a fluid medium by dynamic structure points, and the second simulation section can be configured to simulate one or more substantially solid bodies, in the presence of the fluid medium, by permanent structure points.

According to another aspect of the invention, the simulation manager additionally comprises simulation elements called dual, which are capable simultaneously of possessing permanent structure points and of themselves defining dynamic structure points, and equipped with the designation of a function which is configured to influence simultaneously at least one permanent structure point and at least one dynamic structure point, these dual simulation elements being used to couple the two simulation sections.

According to yet another aspect of the invention, at least one of the simulation sections includes one or more simulation elements of which one function works on an attribute defined as a derived magnitude, and the device also includes at least one integrator simulation element, which is capable of calculating an integral magnitude of the derived magnitude which is contained in another simulation element, and of storing this integral magnitude as an attribute in this other simulation element.

According to one embodiment, the multi-tasking programming environment is capable of working by activatable objects. At least some of the simulation elements are then defined as activatable objects.

It is possible to choose that all the simulation elements are defined as activatable objects. The simulation manager is then configured to work by sequences on a selection of the activatable objects, each of which is activated at most once during each sequence, in an order which varies at least partly randomly from one sequence to another.

There can then be all or some of the following characteristics:
The activatable objects include one or more interaction objects, each containing the designation of at least one permanent structure point and at least one function which is applicable to this permanent structure point.
All the simulation elements are defined as activatable objects or state objects, each containing at least one space and/or time data item and/or at least one attribute data item, each defining a permanent structure point, and a current state of the latter.
Activatable objects comprise so-called enaction objects, which are capable of defining autonomous spatio-temporal entities, each representing a physical phenomenon, and capable of interacting, in the case of activation, with dynamic structure points, each belonging to state objects which are distinct or incorporated in the enaction object.
The activatable objects operate according to a repetitive series of operations: action-perception-decision-action-perception-decision, and so on, a sequence including three consecutive operations in this series.
A sequence begins with perception for an interaction object, or with action for an enaction object.

In the specific application of the virtual test tank, there can also be all or some of the following features:
The first simulation section (SS1) includes simulation elements for at least some of the following phenomena: wave group, wave breaking, group/group interactions, group/breaking interactions, group/wind interactions, group/current interactions and group/depth interactions.
The second simulation section (SS2) includes simulation elements for mechanical characteristics between different sections of a body.

Other features and advantages of the invention will appear on examination of the detailed description which follows, and of the attached drawings, of which:

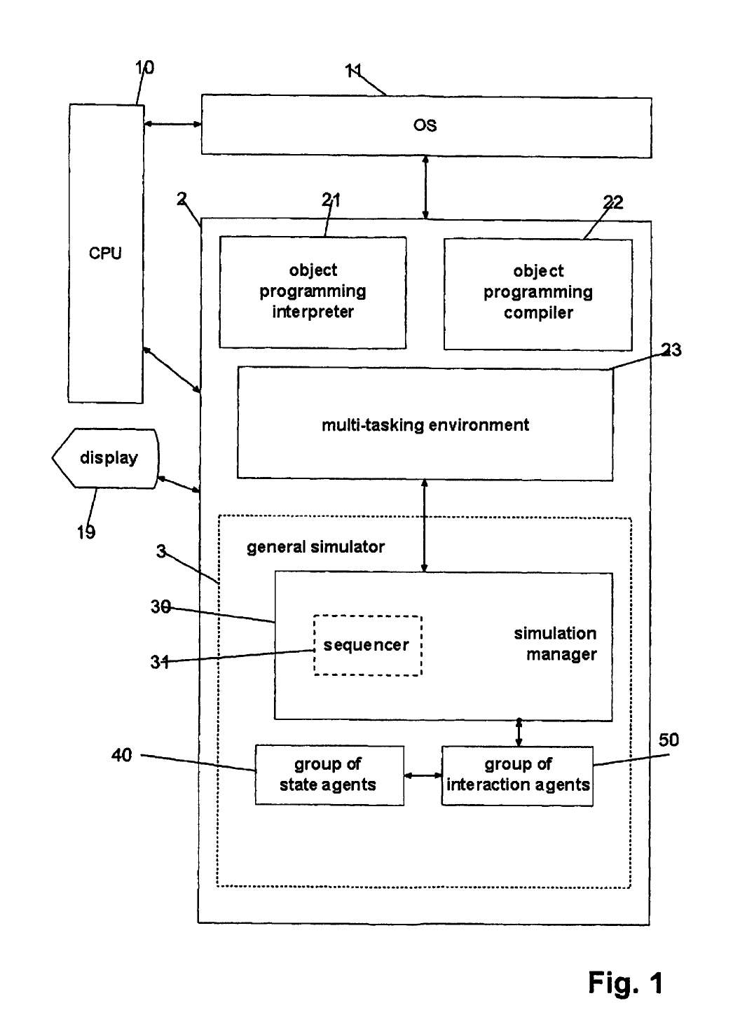

FIG. 1 is an organisation chart of an example of a device according to WO 2005/081141,

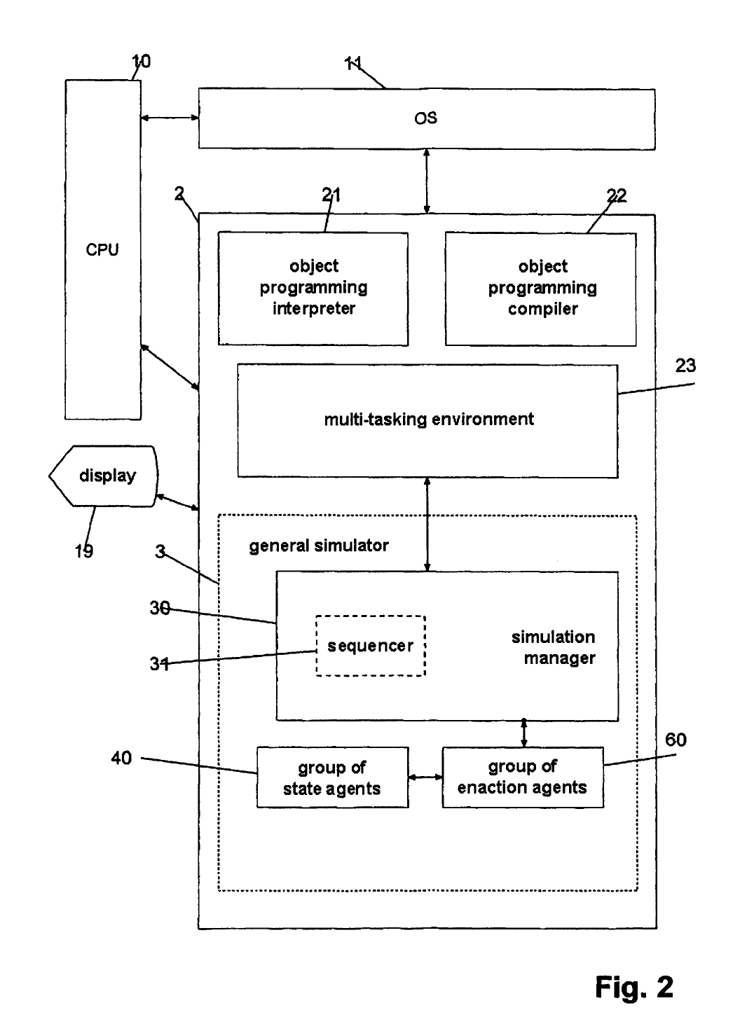

FIG. 2 is an organisation chart of an example of a device according to WO 2006/003271,

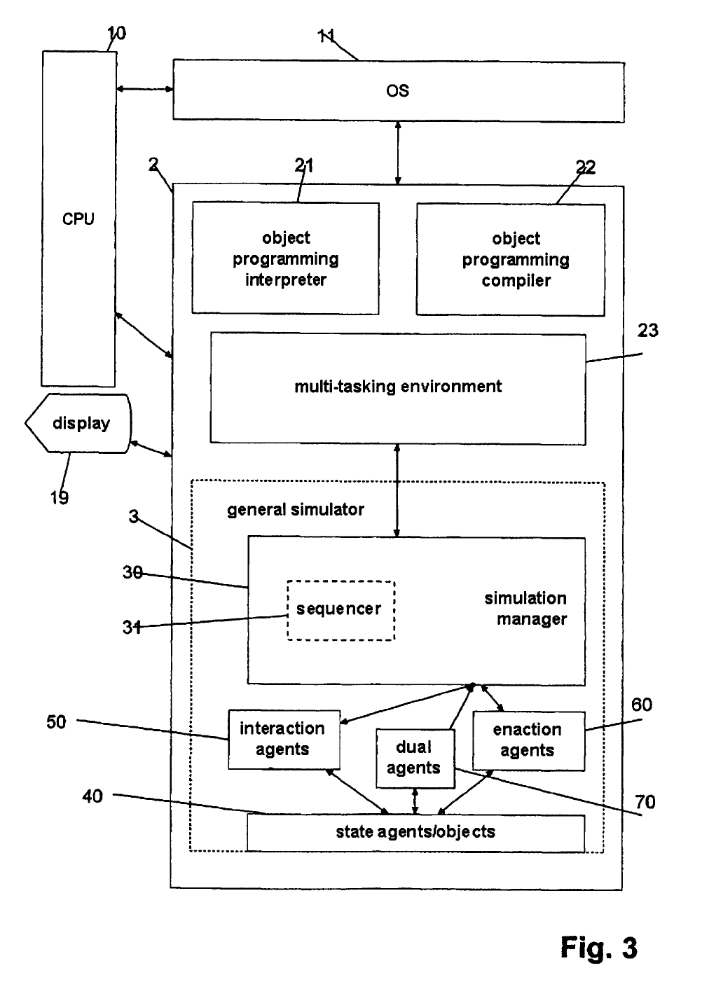

FIG. 3 is an organisation chart of an example of a device according to the present invention,

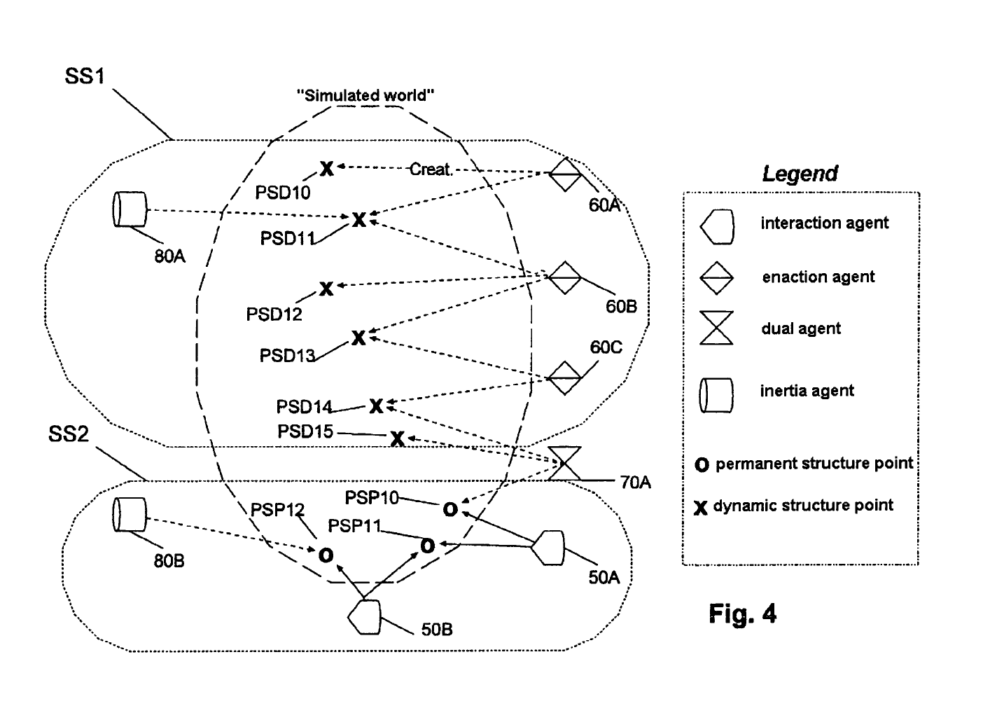

FIG. 4 is a spatial illustration of the respective roles of the agents,

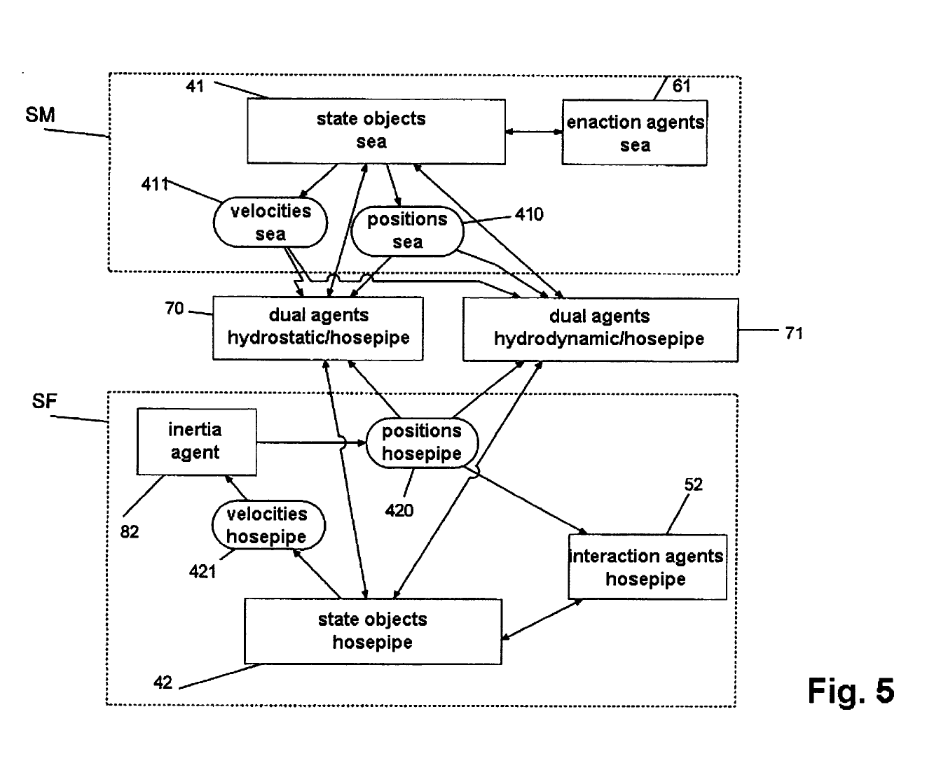

FIG. 5 is a simplified example of agents for the simulation of a virtual test tank,

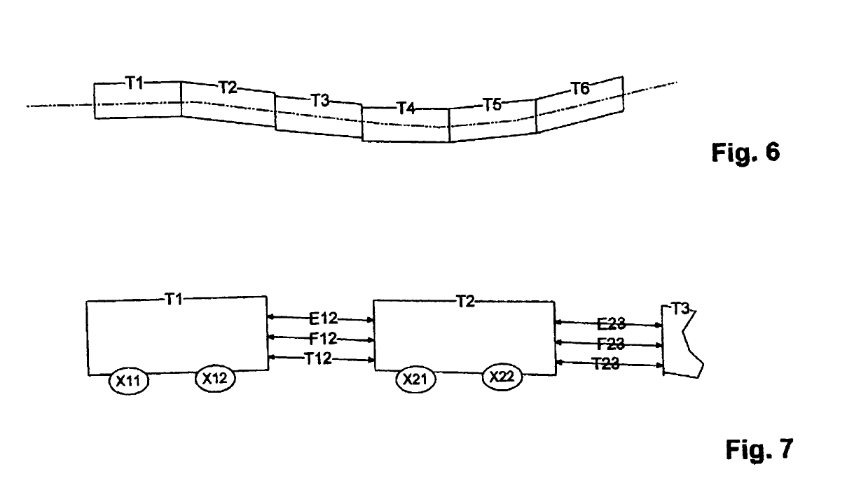

FIG. 6 is a schematic illustration of the splitting of a floating flexible structure into sections, and

FIG. 7 is a schematic illustration of the interactions between a section and the sea, and between a section and the adjacent section.

The drawings and description below basically contain, elements of a certain character. They can therefore be used not only to make the present invention better understood, but also to contribute to its definition if required.

Additionally, the detailed description is supplemented with an Annex 1 of formulae. This Annex is placed separately for clarification, and to make cross-referencing easier. It is an integral part of the description.

Simulation in General

The applicant has promoted a new simulation technique, by asynchronous chaotic agents, which was introduced in WO 2005/081141. What is called here an “agent” is an element of the simulation, in the sense of an elementary building block of the simulation.

This new technique contrasts with conventional simulation techniques, which are synchronous. For example, if two phenomena controlled by the following equations are considered:

y′=dy/dt=f(y)

y′=dy/dt=g(y)

conventional simulation merges the two equations into one (synchronous) system, e.g.:

y′=f(y)+g(y)

which will be resolved by conventional methods by writing (Euler's method):

y(t+dt)=y(t)+f(y(t))*dt+g(y(t))*dt

“Synchronous” is understood to mean that all the events which take place in the time interval dt are simultaneous. This supposition is theoretically exact in the formal equations: since dt is zero (“tends to 0”), two events which take place during the same time interval dt necessarily take place at the same instant. In practice, a shift is introduced when these equations are solved numerically, since dt is transformed into a non-zero Dt, which can make it necessary to take special precautions.

Where a conventional numerical method is applied in space, the space is divided into meshes in which flows are calculated, and time is divided into intervals of small, non-zero durations.

An example will show this shift clearly, in the case that several “non-linear” phenomena interact.

Two chemical reactions A+x→B and A+y→C, which are in competition and start with the same reagent A, are considered. It is assumed that these two reactions have the same kinetics, which is constant, i.e. each reaction consumes 1 unit of A per second if it occurs, giving B or C. Now consider a third reaction A+z→C, which has proportional kinetics, meaning for example that it consumes half the available reagent A, provided that the medium is denser in C than in B.

The result of the synchronous simulation technique is that since B and C behave in the same way, the concentration of C will never exceed that of B, and consequently reaction 3 will never be activated. Thus if the initial concentration is 10 units of A, at the end of 5 seconds, the medium will contain 5 B and 5 C.

However, reality is different: it is not synchronous. One of the two reactions will act before the other. In fact, it is probable that in the course of time, the concentration of C at a given moment will (by accident) exceed that of B. The reaction A+z→C will then act rapidly and maintain this disequilibrium, which the synchronous simulation technique is incapable of predicting.

The new technique according to WO 2005/081141 does not consider the effects of f and g as synchronous. It calculates the contributions of f and g separately, respecting the causalities: if g acts after f, then g acts on the world as f has left it. It is therefore possible to write:

y(t+dt1)=y(t)+f(y(t))*dt1

y(t+dt1+dt2)=y(t+dt1)+g(y(t+dt1))*dt2

If dt is taken as =dt1+dt2, these two lines do not combine as in the conventional method, since the result will be

y(t+dt)=y(t)+f(y(t))*dt+g(y(t+dt1))*dt

It has been shown that simulation by asynchronous chaotic agents according to WO 2005/081141 converges to a correct solution in numerous cases. In particular, it always converges to a correct solution for phenomena which are controlled by first order differential equations.

There have been successive approaches to simulation by asynchronous chaotic agents. They differ in the classes of agents which are used, and which themselves depend on the phenomena to be simulated. Asynchronous chaotic functionality makes it possible to simulate the different phenomena independently by different agents.

The Approach by Entity Agents

This first approach considers at least two elements of the environment.

Each element of the environment is represented in information technology by an entity agent, with
on the one hand, data which describe the parameters of this entity agent, and
on the other hand, data or methods which represent the rules which control the linked evolution of the parameters of this entity agent, and the parameters of other entity agents which are present in the environment (the other element(s) of the environment).

An entity agent can represent an element of the real world: molecule, particle of water, person, for example, with its evolution rules. In a sense, an entity agent is simultaneously the subject and the object of the simulation.

Within the simulation by asynchronous chaotic agents, each entity agent will follow a perception/decision/action cycle conforming to Table A1 below.

TABLE A1

| ID | Step | Detail of step |
|---|---|---|
| A11 | percep- | perceiving other entity agents which surround the entity |
| | tion | agent being considered (in other words, perception of the |
| | | environment) |
| A12 | decision | deciding on the attitude to adopt according to the specific |
| | | functional rules of the entity agent being considered |
| A13 | action | modifying the parameters of the entity agent being |
| | | considered, and/or the parameters of other agents |

It will be understood that entity agents make it possible to construct a simulation program in a conceptually simple manner. Also, this construction is modular, to the extent that a simulation program is the combination of multiple agents, i.e. multiple small simulation programs.

On the other hand, multiplying the number of agents can become explosive very quickly. For example, in a chemical simulation, simulating the behaviour of each molecule individually is inconceivable in practice, at least for now.

Additionally, the modularity of this method has its limits. In fact, the simulator taking account of a new phenomenon (e.g. taking account of a new chemical reaction, or of thermal transfers which have not been processed until now) necessitates:
identifying those of the entity agents which this new phenomenon concerns, and
rewriting, at least partially, each of the entity agents which this new phenomenon concerns.

The Approach by Interaction Agents

This approach is one of the elements which are illustrated in WO 2005/081141.

FIG. 1 shows a technique for asynchronous chaotic simulation according to WO 2005/081141 (drawn from its own FIG. 1).

It can be carried out on an IT station which includes a central processing unit 10 and an operating system 11. These are the basis of a simulation environment 2, which can be the oRis environment which is described, in particular, in the document “Systèmes multi-agents (multi-agent systems)”, pp. 499 to 524, RSTI-TSI, 21/2002.

The environment 2 allows programming by activated objects, e.g. in the C++ or Java language. The multi-tasking environment oRis is linked to a compiler 22 (here called “object programming compiler”). The oRis environment can also be linked to a translator 21 into the C++ language (here called “object programming interpreter”) to improve its efficiency by compilation. This interpreter 21 can even be adapted to form an on-line compiler, in which the executed code is code which is compiled on line and can be modified dynamically. Such a multi-tasking environment, forming a development of oRis, is known by the name of ARéVi. The whole provides a multi-tasking simulation environment 23, on which the simulation is based. The central unit 10 is equipped with a high performance graphics card (not shown), which makes it possible to show the simulation on a display 19.

A particular simulation is carried out by a general simulator 3, which firstly comprises a simulation manager 30, which is equipped with one or more sequencers 31.

According to WO 2005/081141, the elements of the simulation comprise interaction agents 50 and state objects 40, which will be called here entity agents or entity objects, to which we shall return.

Thus the world is on the one hand split into phenomena, such as chemical reactions or wave propagation, and on the other hand split into pieces, or compartments. The following must be distinguished:
on the one hand, the modeling of the environment, with its IT structuring, which is a passive object of the simulation, and
on the other hand, agents and their functional rules, which are the true actors of the simulation, and are called interaction agents.

Where the technique by interaction agents is applied to a phenomenon which is distributed in space, it is not imperative that the interaction agents are located in the space; but the space then remains divided into compartments, represented by entity objects.

An interaction agent has the same general “perception/decision/action” cycle as the entity agents described above. On the other hand, the “perception/decision/action” cycle no longer applies to interactions between entity agents (perception of other entity agents, decision and actions on other entity agents). Each interaction agent will now interact with the environment (perception of the environment, decision, action on the environment). It can therefore be considered that the IT representation of the environment itself is “inert”, since this IT representation has no tools or methods of action. These tools or methods of action are in principle located in the interaction agents. This is summarised in Table I1 below.

TABLE I1

| ID | Step | Detail of step |
|---|---|---|
| I11 | percep- | perceiving data which represent the environment (“entity |
| | tion | objects”) |
| I12 | decision | deciding on the attitude to adopt according to the specific |
| | | functional rules of the interaction agent being considered |
| I13 | action | modifying the data of the environment and/or the |
| | | parameters of the interaction agent being considered |

In the example of a simulation of chemical phenomena (not spatialised), the environment is represented by a list of concentrations for each type of reagent which is present. The agents represent the chemical reactions. Their perception/decision/action cycles then become:
reading the concentrations of products by an agent,
calculating as a function of the internal kinetic parameters of the agent,
modifying the concentrations of the products of the environment; to this can be added modifying the considered agent's own kinetic parameters, e.g. if the environment indicates the presence of a catalyst for the reaction for which the considered agent is responsible.

In the “interaction agent” approach, spatial representation is obtained by structuring the environment into different compartments (called reactors in the context of chemical simulations).

Each compartment is situated in space, and houses a list of parameters (concentrations in the chemistry example). Each compartment also houses one or more intra-compartment (non-spatialised) interaction agents. Finally, at the interface between compartments, there are inter-compartment (spatialised) interaction agents, the special feature of which is that they can act on several compartments at once.

An intra-compartment interaction agent perceives the specific environment of its compartment (that which concerns it at that instant), calculates its actions, and acts by modifying the parameters of the environment of its compartment. In the case of chemistry, that will be: read the concentrations of my compartment, calculate, modify the concentrations of my compartment.

An inter-compartment interaction agent perceives the specific environments of a group of compartments, calculates its actions, and acts by modifying the parameters of the environment of its group of compartments (the group of compartments which concerns it at that instant). In the case of chemistry, they will be responsible for phenomena of diffusion or transport. For example:
reading the concentrations [A]₁ and [A]₂ in two adjacent compartments, calculating the difference [A]₁−[A]₂,
writing the new concentrations:

[A]_{1new}=[A]₁−c*([A]₁−[A]₂);

[A]_{2new}=[A]₂+c*([A]₁−[A]₂)

Better splitting of the functions of the simulator is thus achieved, from the point of view of the modeling work. Each agent is responsible for a specialty. Thus in the case of a medium which mixes chemical phenomena and thermal phenomena, some agents will concern themselves only with chemistry, others with thermodynamics.

Adding new phenomena (e.g. dispersion of heat on the walls of the tube) does not affect the programming of existing agents.

Thus the structuring of the environment (the world model) can be explicitly described at the moment of writing a simulation program, by the programmer. It is the programmer who decides initially on the number of concentrations to be monitored, the number of compartments, etc. The agents are all linked initially to a part of the environment (some concentrations in some compartments, for example). Subsequently, these links can only be modified by an operator, by a program which is explicitly written to modify the links.

It has been found that this a priori created (in a sense “hard programmed”) link between each agent and its part of the environment was sometimes the cause of excessive rigidity. The applicant has thus conceived a new approach, which will now be considered.

The Approach by Enaction Agents

In WO 2006/003271, enaction agents (“enaction objects” according to the terminology of WO 2006/003271) are involved.

FIG. 2 shows an asynchronous chaotic simulation technique according to WO 2006/003271 (its own FIG. 5). It differs from FIG. 1 in that the interaction agents are replaced by enaction agents 60 (“enaction objects” in the terminology of WO 2006/003271).

The approach by “enaction agent” retains some of the attributes of the agents described above:
the world is still split into phenomena
the agents which represent these phenomena do not interact directly with them, but only via their interactions with the environment
the environment is not an actor of the world, but a mere description.

The difference is that the structuring of the environment is not explicitly given once and for all by the programmer, but can be constructed dynamically by one or more “enaction agents”.

Consequently, where a technique by enaction agents is applied to phenomena which take place in space, it is no longer necessary to divide the space into pieces or meshes. The magnitudes are calculated only where the agents judge it to be necessary (at the measurement points). In other places in the space, where there is no measurement point, the magnitudes to be calculated are quite simply not even known (even approximately). Each measurement point represents only itself (and an area surrounding it if required). But that cannot be called a mesh, since there is no meshing covering the whole space. On the contrary, there could be two measurement points in the same place.

Each enaction agent follows a cycle of the type of that of Table E1 below.

TABLE E1

| ID | Step | Detail of step |
|---|---|---|
| E11 | action 1 | creating structure points in the environment |
| E12 | action 2 | action(s) on the structure points which are present in the |
| | | environment, as a function of the internal parameters of |
| | | the enaction agent being considered; the action can affect |
| | | the structure points which this enaction agent has already |
| | | created in E11, or those created by one or other enaction |
| | | agent(s) (in their own step E11) |
| E13 | percep- | reading the parameters of the structure points of the |
| | tion | enaction agent being considered (as already created by it |
| | | at the first step E11 of a cycle), |
| E14 | decision | with, if necessary, updating the internal parameters of |
| | | the enaction agent being considered, as a function of the |
| | | parameters thus read in E13 |

In WO 2006/003271, the structure points are called “interaction mediators”, since the enaction agents interact with each other only via their actions on these points.

Fields of Application

Each of the multi-agent approaches described above has preferred applications.

The approach by interaction agents suits chemical reactions, with or without spatialisation. It also applies very well to modeling mechanical structures.

The approach with enaction agents suits oceanographic modeling of the sea, for example, particularly well. But it is rather unsuitable for modeling gravitational interaction between multiple bodies.

Thus problems can occur when more complex situations, which involve multiple elements of different types, are simulated. This is the case, for example, for simulation of a flexible structure (pipe) floating on the sea. This is a necessary step for simulating a virtual hull tank, or more simply a “virtual test tank”, where numerous mechanical structures float on and/or in the water.

In fact, such a simulation cannot be done with interaction agents only or with enaction agents only.

The result is the impossibility of simulating, for example, a “virtual test tank” by the technique of asynchronous chaotic agents. Which is unfortunate in view of the impressive capacity of this technique for oceanographic modeling of the sea.

Additionally, in certain mechanical applications, including the virtual test tank, it is necessary to take account of second order differential equations. This also raises a problem: in fact, with the technique of asynchronous chaotic agents, convergence is not assured for second order differential equations.

Nevertheless, the applicant has endeavored to find solutions, as part of its work on the virtual test tank.

FIG. 3 shows an asynchronous chaotic simulation technique according to the present invention. As for FIG. 1, the elements of the simulation include a group of interaction agents 50 and a group 40 of state agents and/or state objects 40 (also called entity agents or entity objects here). As for FIG. 2, the simulation elements include a group of enaction agents 60. Finally, special agents with dual function, called “dual agents”, are added, and are responsible for ensuring a link between the interaction agents 50 and the enaction agents 60, via dynamic structure points, as will be shown.

One of the basic ideas which led to the solution consists of distinguishing two categories of “structure points”.

These categories have in common the fact that a structure point contains:
data which define a point in space/time, and
data which define one or more attributes of this point in space/time.

Space/time is not necessarily real space with 3 dimensions. It can be confined to a much smaller space domain, e.g. the inside of a test tube in chemistry.

A permanent structure point is attached permanently to a physical element which is present in space, e.g. the section of tube which will be considered below. It follows that the permanent structure point is attached permanently to one or more agents which are responsible for processing the physical element concerned. This is defined initially at programming.

In general, a permanent structure point is not fixed in space. The data which define it in space/time will therefore vary. For example, the section of tube which will be considered below moves. The qualifier “permanent” means that the structure point remains present, with the same meaning or physical attachment, throughout the simulation. There can be exceptions to this permanence, for example if the physical element to which the structure point is attached disappears, and of course if a human operator forces the disappearance of the structure point.

In contrast, a dynamic structure point has no localised physical attachment. The data which define it in space/time can therefore be modified by the agents with no physical constraint, within the domain of the simulation, depending on the requirements of the simulation and display. Creating a dynamic structure point therefore consists in principle of making a supplementary structure multiplet {space/time data, attribute data}. However, it often happens that a dynamic structure point is used only once, and is then destroyed (in the next sequence) by another dynamic structure point.

The words “structure point” also mean that the data which make up the permanent structure points have a general construction like that of dynamic structure points.

Interaction Agents and Permanent Structure Points

Interaction agents (or another non-enaction agent) are associated in principle with the permanent structure points as defined above. Such a non-enaction agent operates according to the “perception/decision/action” cycle. In the case of an interaction agent, this cycle is that of Table I2 below.

TABLE I2

| ID | Step | Detail of step |
|---|---|---|
| I21 | percep- | reading the environment (i.e. permanent structure points) |
| | tion | |
| I22 | decision | calculating as a function of the permanent structure points |
| | | and my internal parameters |
| I23 | action | modifying the environment (i.e. permanent structure points) |

Perception and action are done on the structure points which are explicitly linked (since the creation of the agent) to the agent.

Enaction Agents and Permanent Structure Points

An enaction agent follows a cycle of the type defined in Table E2.

TABLE E2

| ID | Step | Detail of step |
|---|---|---|
| E21 | action A | creating new structure points in the environment |
| E22 | action B | modifying the structure points which are in the area of |
| | | influence of the agent being considered, as a function |
| | | of the internal parameters of the enaction agent being |
| | | considered; the action can affect the structure points |
| | | which this enaction agent has already created in E21, |
| | | or those created by one or other enaction agent(s) (in |
| | | their own step E21), or the permanent structure points, |
| | | which are the only ones the interaction agents see |
| E23 | percep- | reading the parameters of the structure points of the |
| | tion | enaction agent being considered (as created at the first |
| | | step E21 of the cycle) |
| E24 | decision | updating the internal parameters of the enaction agent |
| | | being considered, as a function of the parameters thus |
| | | read, i.e. of the evolution (between steps E21 and E23 |
| | | of this cycle) of the structure points of the agent |
| | | being considered |

The cycle of Table E2 is quite close to that of Table E1, except that in Table E2, the enaction agent can also act on a permanent structure point, which is also accessible to the interaction agents.

It is also possible to define an area of influence around an enaction agent, implicitly or explicitly.

Bifunctional or Dual Agents

It is also desirable to provide a “link” between the interaction agents and the enaction agents. This is useful, for example, for placing dynamic structure points corresponding to the permanent structure points.

This can be done by adding bifunctional agents, which will be called here “dual agents”, and which combine the characteristics of interaction agents with the characteristics of enaction agents.

In the general case, therefore, a dual agent can follow the cycle indicated in Table D2 below, where the “duality” column refers to the steps of Tables I2 and E2 given above.

TABLE D2

| ID | Step | Detail of step | Duality |
|---|---|---|---|
| D21 | action A | creating structure points | =E21 |
| | | | (enaction) |
| D22 | action B | as a function of “my” internal | =I23 |
| | | parameters (those of the dual agent | (interaction) |
| | | being considered), modifying the | |
| | | structure points to which I am | |
| | | explicitly linked (interactive | |
| | | behaviour) | |
| | | and the structure points which are | +E22 |
| | | in my area of influence (enactive | (enaction) |
| | | behaviour) | |
| D23 | percep- | reading the structure points to which | =I21 |
| | tion | I am explicitly linked (interactive | (interaction) |
| | | behaviour) | |
| | | and those which I have created | +E23 |
| | | (enactive behaviour) | (enaction) |
| D24 | decision | modifying my internal parameters as | =I22 |
| | | a function of my permanent and/or | (interaction) + |
| | | dynamic structure points | E24 (enaction) |

A dual agent can therefore have the object structure indicated in Table D3.

TABLE D3
object structure of a dual agent

| ID | Content | Comment |
|---|---|---|
| D30 | list of dynamic structure points | |
| D31 | co-ordinates of a dynamic structure point; | repeated for each |
| | variables defining its attributes | dynamic structure |
| | | point |
| D32 | list of permanent structure points | list, or hard coded |
| D33 | co-ordinates of a permanent structure | repeated for each |
| | point; variables defining its attributes | permanent structure |
| | | point |
| D34 | names of variables defining the internal | list, or hard coded |
| | parameters of the dual agent | |
| D35 | values of variables defining the internal | |
| | parameters of the dual agent | |
| D36 | designations of useful functions for | |
| | modifying the internal parameters of the | |
| | dual agent as a function of the dynamic | |
| | and/or permanent structure points | |
| D37 | area of influence of the dual agent | |

This structure is only an example, and numerous variants are possible. For example, a single list can include dynamic and permanent structure points. The result of using naming patterns can be that these lists can be reconstructed automatically, without having to be stored. On another level, it is possible to store not the designations of functions but their expression, integrating the names of variables which are concerned in the dual agent object, in which case it may be unnecessary to list at least some of these variables.

Additionally, as was shown above, the space/time co-ordinates of a structure point (or more than one), and all or some of its attributes, can be stored separately, in a state object, or even in another agent or object.

With one or more dual agents, the IT description of the environment can be shared among a group of interaction agents and a group of enaction agents.

At least some of the dual agents can be replaced by equivalent functions, which can then be held at least partly in existing agents.

This is indicated in FIG. 4, which shows a generic modeling structure having all the inputs of this patent application.

In this FIG. 4, the environment comprises dynamic structure points PSD10 to PSD15, and permanent structure points PSP10 to PSP12.

Interaction agents 50A and 50B interact with the permanent structure points PSP10 to PSP12, as shown. Enaction agents 60A to 60C interact with the dynamic structure points PSD10 to PSD15, as shown. A dual agent 70A interacts with the dynamic structure points PSD14 and PSD15, and with the permanent structure point PSP10, thus providing a gateway between the top sub-environment (the PSDs), simulated by enaction agents, and the bottom sub-environment (the PSPs), simulated by interaction agents.

If necessary, an inertia agent 80A (see the “Inertia agents” section below) interacts with one of the dynamic structure points, here PSD 11, to convert, for example, a velocity supplied by a function of an enaction agent into a position.

Similarly, if necessary, an inertia agent 80B interacts with one of the permanent structure points, here PSP 12, to convert, for example, a velocity supplied by a function of an interaction agent into a position. It should be remembered that in mechanics, for example, second order differential equations in position are preferably converted into first order equations in velocity, to be processed convergently by the technique of asynchronous chaotic agents.

A first simulation section SS1 can be defined around the agents 60A to 60C and 80A. A second simulation section SS2 can be defined around the agents 50A, 50B and 80B. One or more dual agents such as 70A are between the two.

The structure points are represented separately for the clarity of the drawing, but they may be found in the same place in space, between permanent structure points and dynamic structure points, at least two by two.

The structure points can even be defined within the agents. But it will often be more convenient to distinguish them from the agents. In this case, a structure point can be defined as a state object, or entity object, containing the space/time co-ordinates of the structure point, with at least one attribute data item, defining a current state of the structure point. The agent then comprises a pointer to the structure point, and the designation of at least one function, which can be applied to modify the current state of the structure point. However, different distributions are conceivable. For example, if an attribute of a structure point is processed by only one agent, it can be stored in this agent, even if the structure point is stored separately in a state object.

Additionally, the fact that an agent comprises the “designation of at least one function” must be understood in a broad sense: it can involve a character string which forms a call of an existing function, a section of program code which defines a function, or a pointer to a place where such code is found, for example.

It must be understood that the permanent structure points are not necessarily fixed in space. They are merely permanently attached to points of a structure, e.g. three-dimensional.

In contrast, a dynamic structure point is not attached to a structure, and it can be placed anywhere, conforming to the program code which is provided for this purpose in the enaction agent which manages it.

In a good number of applications, the dynamic structure points are renewed at each cycle or sequence of asynchronous chaotic activation of agents, as a function of the requirements for coincidence or adjacency between them and the permanent structure points.

Practical Comments

The environment is then initially configured explicitly by the programmer, who will create a certain number of structure points, each having parameters (for example, flexible structure sections, of which the parameters will be their positions, orientations, velocities, etc.).

The enaction agents, in the course of simulation, will complete this structuring by adding their own, dynamic, structure points (interaction mediators).

Otherwise, each agent acts as it usually does on the environment, independently of what the others do.

In the case of the enaction agent, the agent is not linked initially to any structure point (furthermore, initially these structure points do not even exist; it is up to this and other enaction agents to create them). On the other hand, it is implicitly linked to structure points, either because it created them, or because they are in its area of control (or area of influence). It should be noted here that the structure points to which an enaction agent is linked vary constantly.

The dual agents are linked explicitly to both the pre-existing structure points and the structure points which they have created themselves. Their behaviour is therefore both interactive and enactive. The person skilled in the art will understand that the dual agents form an interface between the world of enaction agents and the world of interaction agents.

One of the elements of the reasoning which resulted in dual agents was the observation that it was possible to give to enaction agents a sequence of steps which was compatible with that of interaction agents, that is:
action/perception/decision, for the cycle of an enaction agent,
perception/decision/action, for the cycle of an interaction agent.

It is observed that the step forming the start of the cycle is different in the two cases: “action” for the cycle of an enaction agent, and “perception” for the cycle of an interaction agent. But the applicant has also observed that, in simulation by asynchronous chaotic agents, the obtained result does not in practice depend (at least statistically) on the step chosen as the start of the cycle. This observation has formed another of the steps towards the conception of dual agents, by making it possible to:
bring the interaction agents and enaction agents together in a single simulation by asynchronous chaotic agents, and
combine their two respective cycles to construct the new type of agent, the dual agent, without jeopardising simulation by asynchronous chaotic agents in this way either.

The above makes it possible, for example, to “couple” a simulation of the sea, by enaction agents, and one or more simulations, by interaction agents, of mechanical structures (such as a floating pipe). Dual agents achieve the coupling at predefined structure points, whereas others can be created dynamically.

This is a “building block” for constructing the simulation of the virtual test tank.

Inertia Agents

There remains the problem associated with second order differential equations, which control the movements of the pipe as a function of the stresses which are applied to it.

This involves processing the phenomena which bring in the second derivative and first derivative of a magnitude y, that is:

d²y/dt²=f(y), and

dy/dt=g(y)

This can be done as follows:
maintain two data items which are contained in the environment and common to all the agents, that is

y″(t)=current value of f(y)

y′(t)=current value of g(y)
limit the role of the existing agents to calculating the first derivative, that is

y′(t+dt)=y(t)+y″(t)*dt
provide a supplementary agent (here, an “inertia” agent), which is responsible for calculating the new integrated values of the magnitude y, from this first derivative and the preceding integral value, i.e. calculating the operation

y(t+dt)=y(t)+y(t)*dt

Straightforward application of the techniques described in WO 2005/081141 and WO 2006/003271 would have wanted the agents to calculate the operations:

dy/dt(t+dt)=dy/dt(t)+y′*dt

y(t+dt)=y(t)+y(t)*dt

It will be noted that the approach proposed here is significantly different.

It should be properly understood that:
The fact that the inertia agent is separated from the others implies that it will itself act chaotically and asynchronously in relation to the other agents. The value of y′(t) which it will use is not known a priori.
Since the agents are not made to use the same frequency (or period dt), the inertia can be calculated at a different frequency from that which is used for the physical phenomena which are processed.

This separation of inertia in relation to the basic phenomena which control the interactions ensures that the technique of simulation by asynchronous chaotic agents functions (remains convergent) despite the presence of phenomena which involve a second derivative.

The inertia agent can be considered as a particular variety of interaction agent.

Particular Application

In particular, the invention is applied to what will be called here a virtual water test tank, or virtual test tank for short. Such a device comprises a simulator of an aquatic medium which is at least partly delimited (a seabed), where swell conditions occur, and can be regular or irregular. To this one or more simulated structures, mechanical or other, are added. The aim is to take account of the phenomena resulting from the interactions between, in particular, the sea, the wind, the seabed, the structures.

Such a virtual test tank makes it possible to test, at reduced cost, the viability and behaviour of a given structure, in any sea conditions. The sea conditions are defined by giving an oceanographic model and its parameters. It is thus possible to reproduce the sea states of any area (e.g. the Gulf of Guinea) in any conditions, irrespective of, for example, the wind, or the magnitude Hs (significant wave height), which is the mean height between the crest and trough of a wave.

Additional structural elements can be added to this test tank. These elements can be combined to construct the structures to be tested, thus making it possible to use this test tank for practically any type of structure. In the first tests to be carried out, the available structural elements are:
small thread-like structures such as flexible structures, “risers”, or rigid pipes in particular,
large floating or non-floating bodies, including ships or platforms, which influence the swell.

As in the technique by enaction agents, it is unnecessary to divide the space into pieces. The space is represented by structure points (or measurement points) where this is useful.

The magnitudes are calculated only where the agents judge it to be necessary. In other places in the space, where there is no measurement point, the magnitudes to be calculated are quite simply not even known (even approximately). Each measurement point represents only itself (and sometimes effectively an area surrounding it—but that cannot be called a mesh, since there is no meshing covering the whole space; on the contrary, there could be two measurement points in the same place).

A structure point, whether permanent or not, is characterised by co-ordinates in space and “attributes”. These co-ordinates can be those of a predefined point of the “area of influence” of the structure point, e.g. the centre if it is a sphere, or the top left corner if it is a square. The co-ordinates also include the definition of the extent of the area of influence, implicitly or explicitly.

For a mechanical object, the attributes comprise, for example, a force vector and/or a torque vector (or their scalar equivalents with multiple components); in chemistry, the attributes are concentrations of chemical substances (reagents), which are present in the compartment. Other attributes can be used for other application domains.

In an agent, an “action” uses one or more functions which make it possible to define new values for one or more co-ordinates, and/or one or more attributes, as a function of the preceding values of the co-ordinates of the structure points, their attributes and specific internal parameters of the agent concerned.

Additionally, in an agent, the decision can include at least one other function to make the specific internal parameters of this agent evolve, and/or to create or destroy other agents, in particular.

Finally, in an enactive or dual agent, the decision can include one or more other functions to make the structure points which are accessible to this agent evolve, perhaps with creation of structure points (not permanent, i.e. not accessible to interaction agents).

Creating a structure point implies not only defining its co-ordinates and attributes, but also activating all the required functions for later processing of this structure point.

Thus, when it creates a structure point for a new phenomenon, an enactive or dual agent will establish the “required functions for later processing of this structure point”. It will leave these functions (in practice, a designation of these functions) in the environment, associated with a measurement point which it creates. Another agent going there can then retrieve this designation of function(s) at the same time as the measurement point. It applies the thus retrieved functions, with the parameters which are designated in the measurement point as arguments.

In other words, a structure point can include, as attributes:
one or more function designations,
one or more designations of parameters (variable names) to be applied to each function,
values, including the values of parameters for the functions.

Particular Example of an Application

A generic element of the virtual tank is simulation of the action of the sea on a floating object, which will be taken as a floating flexible structure.

FIG. 5 shows the generic elements of the simulation, which should be considered as IT classes, which can be instantiated as required by the needs of the simulation.

Thus, a floating flexible structure interacting with the sea is considered. Simulation of such an interaction necessitates the co-evolution of two simulators (FIG. 5):
a sea simulator SM, which in fact itself consists of simulators of various phenomena such as swell and wind, and
a flexible structure simulator SF.

The sea is an extremely complex object, much too expensive to simulate by meshing its surface. It is simulated here according to the technique by enaction agents 61, conforming to the teaching of WO 2006/003271.

In this technique, each phenomenon (wave group, breaking, etc.) is an enaction agent 61. The agents do not communicate with each other, but interact implicitly because they share the same environment, that is dynamic measurement points, which can be defined (and are therefore chosen) dynamically. One way of sharing a dynamic measurement point consists of placing it in a state object, which each agent which “owns” this dynamic measurement point accesses. In each dynamic measurement point (or state object) 41, at least one of the agents defines a position 410 and a velocity 411. It is because they are influenced by the environment, and influence it in return, that the agents influence each other indirectly.

Additionally, a special feature of the technique by enaction agents is that this environment is not meshed, but is structured by the agents themselves as a function of their requirements (see Table E2, which lists the steps of the enaction agent cycle). This is what brings the oceanographic model of the sea alive. This model can include enaction agents for all or part of the elements of Table M2 below.

TABLE M2

| Modelled | | |
|---|---|---|
| phenomenon | Physical models | Parameters |
| wave group | waves localised by an envelope | age, spectrum, number of |
| | of finite extent, propagated along | principal waves, mean wave |
| | “rays” analysis by wavelets | vector, mean position, group |
| | with 2D Morlet analyser | velocity, envelope |
| breaking | active breaking: breaking criteria, | width of breaking fronts, duration |
| | breaking activity | of active phase, quantity of |
| | passive breaking: progressive | action, depth of foam, duration of |
| | disappearance of turbulence and | relaxation |
| | foam by relaxation | |
| group/group | kinematics: interaction by | wave vectors, pulsations and |
| interactions | breakings | amplitudes of groups in |
| | resonance: interaction of | interaction |
| | quadruplets | |
| group/breaking | transfers of action and dissipation | particle/crest velocity, depth of |
| interactions | of short waves by passive foam; | foam, length of dissipated waves |
| | lengthening of crests; increase of | |
| | number of waves | |
| group/wind | age of a sea state: velocity of | “upper wind” vector field, wave |
| interactions | friction, transfer of energy to sea | vectors, camber, rate of advance |
| | | of the crest of a wave |
| group/current | conservation of crests and of | “surface current” vector field, |
| interactions | action; refraction and widening of | wave vectors, group pulsations, |
| | groups by current gradients | amplitudes and local phases of |
| | | waves |
| group/depth | conservation of crests and of | bathymetry, mean wave vectors, |
| interactions | energy; dispersive refraction and | mean pulsations of groups, |
| | widening of groups | amplitudes and local phases of |
| | | waves |

On this basis, we will have, for example, a wave group, which puts measurement points onto the water; lets the other agents (other groups, breakings, etc.) impact on these measurement points; plots these measurement points, and consequently changes its internal parameters (velocity and frequency of group in particular).

Other details on the simulation of the sea can be found in the article “Comparison of sea state statistics between a phenomenological model and field data”, Christophe LE GAL, Michel OLAGNON, Marc PARENTHOEN, Pierre-Antoine BEAL, Jacques TISSEAU, 2007, Proc. Oceans Conf., p. 6.

The simulation SF of the flexible structure is now considered. It too is subject to multiple phenomena:
its weight, which is constant in direction and force
the buoyancy, directed upward (pressure gradient) and of a force which depends on its immersion ratio (i.e. on the relative positions of the buoy and the water surface)
the hydrodynamic interactions, modeled by Morisson's equations.

This type of phenomena can be described by differential equations, and is well modeled by interaction agents 52. Measurement points (or state objects) 42 are thus created throughout the length of the flexible structure.

The sequencer 31 (FIG. 3) is defined generally as follows:
a) it works in successive, repetitive sequences
b) each sequence concerns a particular selection from multiple distinct simulation elements, which are here the various agents involved in the simulation
c) each agent is activated at most once during each sequence
d) the order in which the agents are activated varies in an at least partly random manner from one sequence to another.

Additionally, when it is activated, an agent works on the basis of the current state of the other agents, which may either already have been activated, in which case they are in the new state (for the sequence being considered), or wait their turn, in which case they are still in the old state.

The result of all this is the chaotic asynchronous character of the simulation.

The agents are not all selected at each sequence. An agent can be selected according to different rules. The simplest is not to select an agent who for the moment is necessarily inactive.

Additionally, selection of an agent, or a sub-group of agents, can be constrained to follow a periodicity rule, which can be expressed as a frequency, relating it to the mean duration of execution of a sequence.

Thus Morisson's equations can be processed at the rate of 5 Hz. The elongation phenomenon explained above can be processed at the rate of 1 MHz.

Other phenomena can be processed similarly, on the basis of their own equations, which are known, with for example in the case of the flexible structure:
torsion: 1 kHz
inertia: 1 MHz
weight: 0.1 Hz
flexion: 10 kHz
buoyancy: 5 Hz
interaction with other structures.

Only the sea is processed according to the earlier technique, using simulation elements of the type of enaction agents or equivalent. The structure points (dynamic) are the points of interest for the display on the screen 19.

Two types of agent are created for the flexible structure. The first type (“intrinsic”) concerns mechanical interactions within the flexible structure; the second type (“extrinsic”) concerns interactions between the flexible structure and the sea.

An extrinsic agent is a dual agent 70 which links a measurement point on the flexible structure to a measurement point on the surface of the water. Its role is to calculate the hydrodynamic interactions.

The force which the water exerts on the flexible structure in fact depends on the relative velocity between the water and the flexible structure. The interaction agent which is responsible for applying this force must therefore know the velocity of the flexible structure and the velocity of the water.

This can be done using Morisson's equations, which are quoted in Annex 1, formulae [1] to [3].

In formula [1], for a given flexible structure element:
m is the mass of the flexible structure element
\ddot{x} is the acceleration of the flexible structure element
ρ_{w} is the density of the water
C_{d} is the drag coefficient
Cₘ is the coefficient of “mass of added water”, corresponding to a sheath of water surrounding the flexible structure, and moving with it
Dₑₓₜ is the diameter of the flexible structure section intercepted by the water
Sₑₓₜ is the surface area of the flexible structure section intercepted by the water (its “wet section”)
V is the velocity of the water relative to the flexible structure
\dot{u} is the (absolute) acceleration of the water at the flexible structure.

Formula [2] expresses the evolution of the apparent mass m of the flexible structure element in relation to its raw value m₀ (without added water), plus the mass of added water.

Formula [3] expresses the evolution of the velocity V in relation to its preceding value V₀.

The person skilled in the art will understand that equation [1] can be modeled by iterations on equations [2] and [3].

The water surface is simulated by enaction agents, so that these extrinsic agents are dual, with enactive behaviour to be able to measure the water surface, and interactive behaviour for processing the flexible structure. They are responsible for themselves creating measurement points on the water at places of which they want to know the characteristics (velocity of the water).

The flexible structure is split into elements T1 to T6, as shown in FIG. 6. The mid-line of the flexible structure is shown by a dash-dot line. The length of a section depends on various factors, in particular the required display precision. It can be 50 cm, for example.

FIG. 7 shows the interactions of the first two elements or sections of the flexible structure, T1 and T2. X11 and X12 are two dynamic structure points, which are created for the structural element T1 by one or more dual agents, which are here responsible for the hydrodynamic interaction. One or more permanent structure points, which are integral with the structural element T1, are also processed by this/these dual element(s).

The interactions between two successive sections such as T1 and T2 are now considered. They are processed by “intrinsic” agents.

Thus a linking intrinsic agent is an interaction agent which links two successive measurement points of the flexible structure. Its function is to maintain conformity to the mechanical characteristics of the flexible structure:
elongation (agent E12): keeping the distance between two successive measurement points constant
flexion (agent F12): keeping the radius of curvature formed by the successive permanent measurement points as constant as possible; the constancy of the radius of curvature is altered by the stresses undergone at the measurement point concerned because of the rest of the flexible structure
torsion (agent T12): keeping the angle formed by the successive permanent measurement points between two sections of tube as constant as possible.

In FIG. 7, in X21 and X22 the same indications are found for section T2 as for T1, and in E23, F23, T23, the same indications are found for the section T2/T3 interaction as for T1/T2, as described above.

An example of simulation of the mechanical behaviour of the flexible structure is now considered. The elasticity law is expressed by equation [4], where:
F is the force between two elements,
dl/l is the (relative) elongation, and
k is a constant of elasticity.

Applied to the elongation between two elements T1 and T2 of the flexible structure, this is translated into equations [5] and [6], where
V1 is the velocity of T1,
V2 is the velocity of T2,
m is the mass (here equal) of T1 and T2, and
dl12/l12 is the (relative) elongation between T1 and T2.

Flexion can be processed on a similar basis, with its own equations. It is the same for torsion.

In summary, in addition to the above-mentioned agents which simulate the sea, the following agents are provided for the flexible structure and its interaction with the sea:
Intrinsic agents 52 for mechanical interaction within the flexible structure: these are interaction agents which link two successive points on the flexible structure. They follow a cycle: perception=measuring the position of the flexible structure; decision=calculating the forces to be applied to the flexible structure; action=modifying the velocity of the measurement points as a function of the calculated forces.
Weight: this is an interaction agent, which systematically applies a downward force, unconditionally, to all measurement points linked to the flexible structure. Its cycle is: perception=nothing; decision=trivial (weight downward); action=modifying the velocity of the measurement points to take account of the weight.
Dual extrinsic agents 70 for hydrodynamic interaction: these are dual agents which measure the relative velocity of the water and the flexible structure. Cycle: Action-1: creating (enactive) measurement points on the water on the edges of the flexible structure. Action-2: modifying the velocities of the (interactive) measurement points of the flexible structure to take account of the hydrodynamic forces. Perception: measuring the velocity of the flexible structure (using explicit measurement points) and of the water (using measurement points which were created in the first step). Decision: calculating the relative velocity, the hydrodynamic forces, and the position of the nearest measurement points.
Inertia agent 82: this is an interaction agent, which integrates the velocities 421 of the measurement points of the flexible structure to calculate the new positions 420 of the points of the flexible structure.

The simplest view of the invention would consist of providing one agent per measurement point. But it will often be more efficient to put multiple measurement points per agent. For example, an agent “weight” can process multiple measurement points in one go; better, a single weight agent can process all the measurement points of the flexible structure in one go.

Similarly, a single inertia agent 82 can process all the measurement points of the flexible structure in one go.

In a particular example, there is interest in the impact of a sea, consisting of an irregular swell (IPAS article) and stressed by the wind, on a 100 m flexible pipe. The phenomena which are taken into account for such a study are the buoyancy, the weight, the stiffnesses in tension, flexion and damping of the pipe, and the hydraulic interactions as described by Morisson's equations. These phenomena interact with each other via interaction mediators (according WO 2006/003271). Thus the “swell” phenomenon influences the “buoyancy” phenomenon by modifying the altitude of the interaction mediators which the latter put in place.

Virtual structural elements such as the following can be added:
virtual buoys (simulation of flotation, measuring the elevation, or the elevation and the sea current)
virtual lasers (which measure the elevation but with a technique of simulating the propagation of light, which does not have the same faults as flotation of a buoy)
sensors for force, displacement, velocity, curvature, for example.

This virtual test tank differs from a simple numeric solution in several points:
The simulation of the sea, repeating the sea model of the IPAS article, produces a realistic irregular sea. This is not a simple profile of swell, but a random set of series of waves and statistically equivalent to the required model. Each instant of the simulation is unique.
At any time, an operator can interact with the tank, in the course of an experiment, to add or remove an element, change the simulation conditions, add or remove a structure point, add or remove a constraint, etc.

Going further, the elements of the modeling can include:
regular swells (Airy or other)
irregular swells (IPAS or other), modeled by a set of enaction agents (conforming to WO 2006/003271)
floating or non-floating thread-like elements (flexible or rigid pipes, risers, etc.)
large floating or non-floating bodies, attached or not attached
coastal structures
bathymetry
liquids or particles (sand, solvent, pollutant, plankton)
other elements such as sources of heat, waves, light, etc.

In such a virtual test tank, all the objects themselves structure the environment, function in their own way and are the object of a certain number of phenomena: hydraulic interactions, creation of swell, pressure constraints, interactions between phenomena (conforming to WO 2005/081141).

Thus the phenomena and their influences can be simulated separately, and they co-evolve, each at its own frequency.

Such a virtual test tank makes it possible to replay a simulation in reverse, and in particular to add new elements to it retrospectively. It is thus possible to bring back, retrospectively, a simulation of the instants preceding an exceptional event (such as a villainous wave) to attempt to analyse its precursor elements.

But the invention is not limited to the example of interaction between a mechanical structure and the sea.

More generally, the invention offers a method of simulating a mechanical phenomenon, in which each mechanical interaction acts separately on the velocity of the structures which it influences, via an interaction mediator, and in which each structural element is equipped with its inertia phenomenon, which integrates this velocity to reposition itself in space. An inertia phenomenon linked to a structural element functions at the frequency of the most rapid of the phenomena which act on this same structure. This technique (separation of the mechanical phenomena into multiple phenomena acting on the velocity and one inertia phenomenon) makes it possible to apply to mechanical interactions the simulation method based on the interaction agents of WO 2005/081141, which in principle is not applicable to them.

Even more generally, the invention covers every simulation application in which dual agents are used to link interaction agents and enaction agents, which co-operate with entity objects or entity agents.

### Annex 1

$$\begin{matrix}{m}_{0} \ddot{x} = \frac{1}{2} {ρ}_{w} {C}_{d} {D}_{ext} \vert v \vert v + {ρ}_{w} {C}_{m} {S}_{ext} \dot{u} - {ρ}_{w} ( {C}_{m} - 1 ) {S}_{ext} \ddot{x} & ( 1 ) \\ m = {m}_{0} + {ρ}_{w} ( {C}_{m} - 1 ) {S}_{ext} & ( 2 ) \\ V = {V}_{0} + ( \frac{1}{2} {ρ}_{w} {C}_{d} {D}_{ext} \vert v \vert v + {ρ}_{w} {C}_{m} {S}_{ext} \dot{u} ) \frac{1}{m} Δ t & ( 3 ) \\ f = k \frac{dl}{l} & ( 4 ) \\ {V}_{1} = {V}_{1} + \frac{k \cdot {dl}_{12}}{m \cdot {l}_{12}} & ( 5 ) \\ {V}_{2} = {V}_{2} + \frac{k \cdot {dl}_{12}}{m \cdot {l}_{12}} & ( 6 )\end{matrix}$$

1. Device for simulating the real world, in particular for a fluid/body interaction, and suitable for being installed in a computer which is equipped for supporting a multi-tasking programming environment (23), with
a simulation manager (30), which is capable of working in asynchronous chaotic mode by repetitive sequences (31) on distinct simulation elements (40-70),
such a simulation element working with at least one space/time data item, called a structure point, with at least one attribute data item, defining a current state of the structure point, and with the designation of at least one function, which can be used to modify this current state,
characterised in that the simulation manager (30) comprises
a first simulation section (SS1), which is configured to simulate a fluid medium, and
a second simulation section (SS2), which is configured to simulate one or more substantially solid bodies, in the presence of the fluid medium,
in that the two simulation sections are coupled, and
in that the simulation manager (30) is configured so as to maintain a general periodicity of activation of the simulation elements which differs according to the simulated physical phenomena in one and the other of the two simulation sections.

2. Device according to claim 1, characterised in that the first simulation section (SS1) is used to simulate the sea (SM), and the second simulation section (SS2) is used to simulate one or more bodies which are floating and/or at least partly dipping into the sea (SF), making it possible to produce a virtual test tank.

3. Device according to claim 2, characterised in that the first simulation section (SS1) is configured to simulate a fluid medium by dynamic structure points, and the second simulation section (SS2) is configured to simulate one or more substantially solid bodies, in the presence of the fluid medium, by permanent structure points.

4. Device according to claim 3, characterised in that the simulation manager additionally comprises simulation elements called dual (70), which are
capable simultaneously of possessing permanent structure points and of themselves defining dynamic structure points, and
equipped with the designation of a function which is configured to influence simultaneously at least one permanent structure point and at least one dynamic structure point,
these dual simulation elements being used to couple the two simulation sections (SS1, SS2).

5. Device according to any one of the preceding claims, characterised in that at least one of the simulation sections (SS1, SS2) includes one or more simulation elements of which one function works on an attribute defined as a derived magnitude, and in that the device also includes at least one integrator simulation element (80A, 80B), which is capable of calculating an integral magnitude of the derived magnitude which is contained in another simulation element, and of storing this integral magnitude as an attribute in this other simulation element.

6. Device according to any one of the preceding claims, wherein the multi-tasking programming environment (23) is capable of working by activatable objects, characterised in that at least some of the simulation elements are defined as activatable objects.

7. Device according to claim 6, characterised in that all the simulation elements are defined as activatable objects, and in that the simulation manager (30) is configured to work by sequences on a selection of the activatable objects, each of which is activated at most once during each sequence, in an order which varies at least partly randomly from one sequence to another.

8. Device according to either claim 6 or claim 7, characterised in that the activatable objects include one or more interaction objects (50), each containing the designation of at least one permanent structure point and at least one function which is applicable to this permanent structure point.

9. Device according to any one of claims 6 to 8, characterised in that all the simulation elements are defined as activatable objects or state objects (40), each containing at least one space and/or time data item and/or at least one attribute data item, each defining a permanent structure point, and a current state of the latter.

10. Device according to any one of claims 6 to 9, characterised in that the activatable objects comprise so-called enaction objects (60), which are capable of defining autonomous spatio-temporal entities, each representing a physical phenomenon, and capable of interacting, in the case of activation, with dynamic structure points, each belonging to state objects which are distinct or incorporated in the enaction object.

11. Device according to any one of claims 6 to 10, characterised in that the activatable objects operate according to a repetitive series of operations: action-perception-decision-action-perception-decision, and so on, a sequence including three consecutive operations in this series.

12. Device according to claim 11, taken in combination with claims 8 and 10, characterised in that a sequence begins with perception for an interaction object, or with action for an enaction object.

13. Device according to any one of the preceding claims, characterised in that the first simulation section (SS1) includes simulation elements for at least some of the following phenomena: wave group, wave breaking, group/group interactions, group/breaking interactions, group/wind interactions, group/current interactions and group/depth interactions.

14. Device according to any one of the preceding claims, characterised in that the second simulation section (SS2) includes simulation elements for mechanical characteristics between different sections of a body.
